(19) United States
(12) Patent Application Publication
(10) Pub. No.: US 2011/0056477 A1
(43) Pub. Date: Mar. 10, 2011

(54) BARBEQUE HOOD AND AN ASSOCIATED LIGHTING ARRANGEMENT

(75) Inventor: Benjamin John Leavens, New South Wales (AU)

(73) Assignee: SHIRO AUSTRALIA PTY LIMITED, New South Wales (AU)

(21) Appl. No.: 12/921,743

(22) PCT Filed: Mar. 5, 2009
(86) PCT No.: PCT/AU2009/000272

§ 371 Date: Nov. 30, 2010

(30) Foreign Application Priority Data
Mar. 10, 2008 (AU) 2008901160

(51) Int. Cl. A47J 37/07; F25D 27/00

(52) U.S. Cl. 126/25 R; 362/92

(57) ABSTRACT

I lighting arrangement for a barbeque hood. The lighting arrangement includes a light housing and at least one light. The light housing is adapted for mounting adjacent an interior surface of the hood. The at least one light is mounted to the light housing.

### FIELD OF THE INVENTION

The present invention relates to a barbeque hood and an associated lighting arrangement.

### BACKGROUND OF THE INVENTION

Hitherto, one approach for attempting to illuminate barbeque cooking surfaces used external lamps mounted to the side of the barbeque hood or clamped to the serveries. The lamps use a flexible neck to help position them appropriately. Another approach used lamps connected to the handle of the hood, which illuminate from above when the hood is open. The disadvantages associated with the above approaches include: that the light source shining in from the side does not give optimum illumination to the cooking surface; the inability to illuminate the inside of the barbeque when the hood is closed; that they can get in the way when cooking; and that they are not aesthetically pleasing.

### OBJECT OF THE INVENTION

It is the object of the present invention to substantially overcome or at least ameliorate one or more of the above disadvantages.

### SUMMARY OF THE INVENTION

Accordingly, in a first aspect, the present invention provides a lighting arrangement for a barbeque hood, the lighting arrangement including:
a light housing adapted for mounting adjacent an interior surface of the hood; and
at least one light mounted to the light housing.

The lighting arrangement preferably includes at least one bracket between the hood and the light housing. The bracket(s) is/are preferably attached to the hood by welding and to the light housing by screws.

In a second aspect, the present invention provides a barbeque hood, the hood including:
a hood panel with an exterior and an interior surface
a light housing mounted adjacent the interior surface of the hood; and
at least one light mounted to the light housing.

The hood preferably includes at least one bracket between the hood panel and the light housing. The bracket(s) is/are preferably attached to the hood panel by welding and to the light housing by screws.

The light housing and the hood panel together define an enclosed volume and the hood preferably also includes a fan adapted to remove air from the volume. The light housing preferably includes at least one vent opening therein. The fan is preferably in fluid communication with the volume via a duct, which is preferably mounted to the hood panel.

The hood preferably also includes at least one hood lining mounted to, and spaced apart, from the hood panel.

The hood preferably includes a rear part and a front part. The rear part is preferably fixed to the barbeque. The light housing is preferably mounted to the rear part. The front part is preferably pivotally mounted to the rear part.

### BRIEF DESCRIPTION OF THE DRAWINGS

Preferred embodiments of the invention will now be described, by way of examples only, with reference to the accompanying drawings in which:

FIG. 1 is a perspective view of first embodiments of a barbeque hood and a lighting arrangement, in a closed orientation;

FIG. 2 is a perspective view of the barbeque hood and the lighting arrangement shown in FIG. 1, in an open orientation;

FIG. 3 is a perspective view of the rear part of the barbeque hood and the lighting arrangement shown in FIG. 1;

FIG. 4 is a side view of the rear part and the lighting arrangement shown in FIG. 3;

FIG. 5 is an exploded perspective view of the rear part and the lighting arrangement shown in FIG. 3;

FIG. 6 is a perspective view of second embodiments of a rear part of a barbeque hood and a lighting arrangement;

FIG. 7 is a cross-sectional side view of the rear part and the lighting arrangement shown in FIG. 6 along line 7-7; and

FIG. 8 is an exploded perspective view of the rear part and the lighting arrangement shown in FIG. 6.

### DETAILED DESCRIPTION OF THE PREFERRED EMBODIMENTS

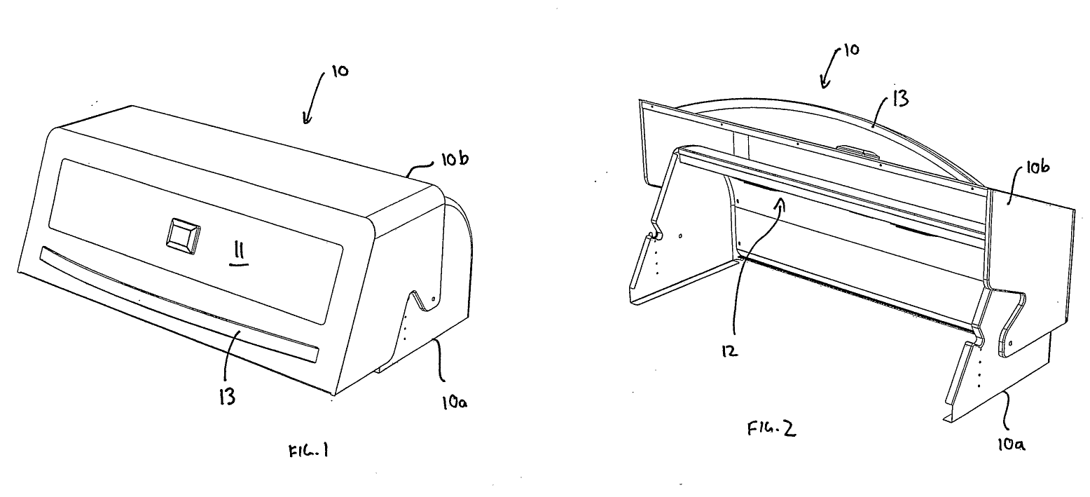

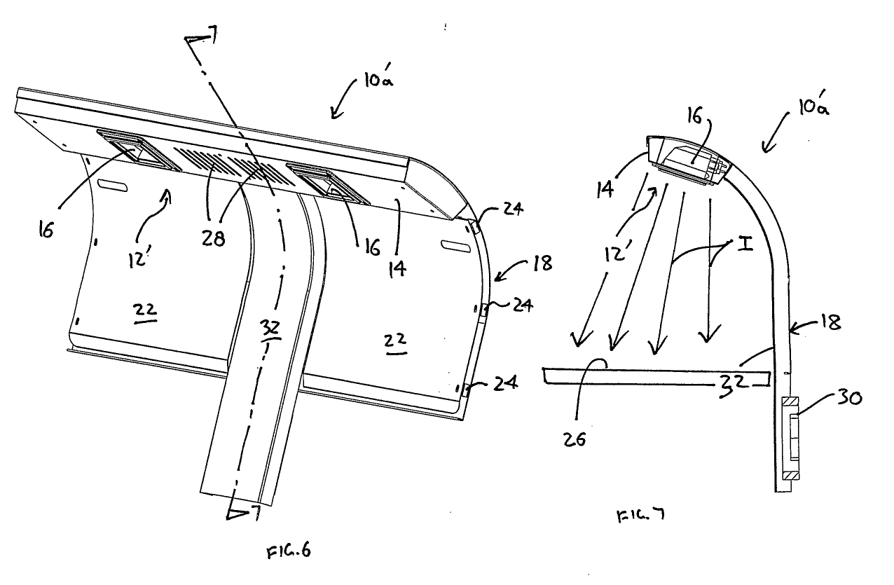

FIGS. 1 to 5 show first embodiments of a barbeque hood 10 and an associated lighting arrangement 12. The hood 10 includes a rear hood part 10a, which is fixed to the barbeque (not shown), and a front hood part 10b, which is pivotally mounted to the rear hood part 10a. The front hood part 10b includes a transparent glass panel 11 and a handle 13.

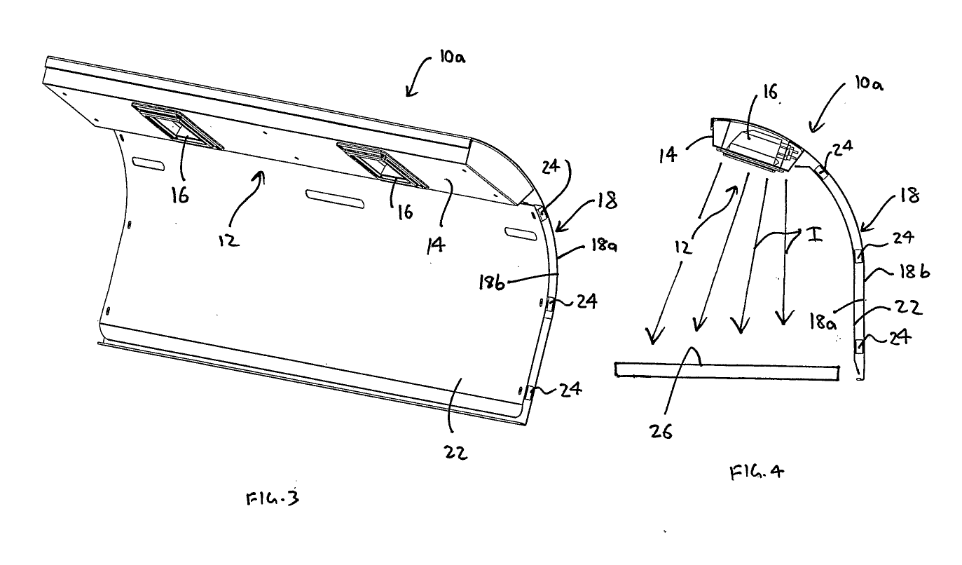

As best shown in FIGS. 3 to 5, the lighting arrangement 12 includes a light housing 14 with a pair of lights 16 mounted thereto. The lights 16 are 12 Volt halogen oven lamps and are mounted to the housing 14 by metal spring clips and screws (not shown). The rear hood part 10a includes a hood panel 18 with an exterior surface 18a and an interior surface 18b. The housing 14 is mounted adjacent the interior surface 18b of the hood panel 18 with three brackets 20. The brackets 20 are attached to the housing 14 by screws (not shown) and to the interior surface 18b of the hood panel 18 by welding.

The rear hood part 10a also includes a hood lining 22 mounted adjacent to, and spaced apart from, the interior surface 18b of the hood 18. The hood lining 22 is mounted to the hood panel 18 by six brackets 24. The brackets 24 are attached to the hood lining 22 by screws (not shown) and to the hood panel 18 by welding.

The electrical wiring (not shown) for the lights 16 passes between the housing/lining 14/22 and the hood panel 18.

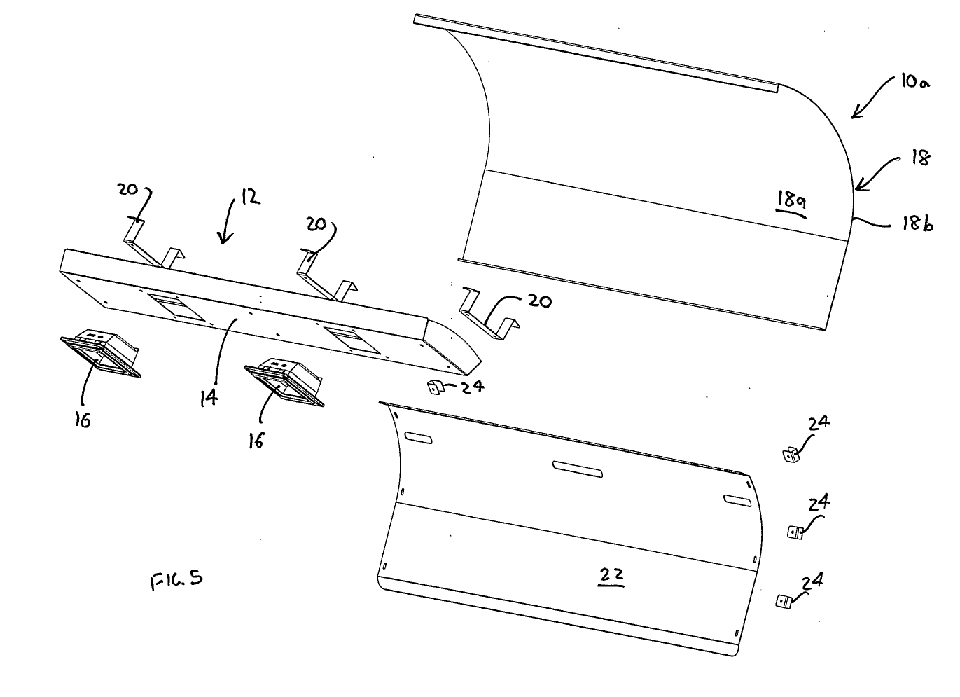

As best shown in FIG. 4, the illumination I emitted from the lights 16 is directed on to a cooking surface 26 of a barbeque.

The advantages of the hood and lighting arrangement embodiments described above are numerous. Firstly, they avoid the use of unsightly fixings protruding through to the exterior surface of the hood. Secondly, the interior volume created between the hood panel and the light housing creates an insulative air gap, which protects the wires providing electrical power to the lights. Thirdly, the volume between the exterior of the hood lining and the interior of the hood panel creates an insulative air gap which reduces the heating of the hood panel exterior surface, thereby improving safety. Fourthly, the hood and lighting arrangement can be manufactured relatively easily and cost-effectively due to the majority of the components being formed from folded steel sheet. Finally, the lights illuminate the barbeque's cooking surface regardless of whether the front hood part is open or closed.

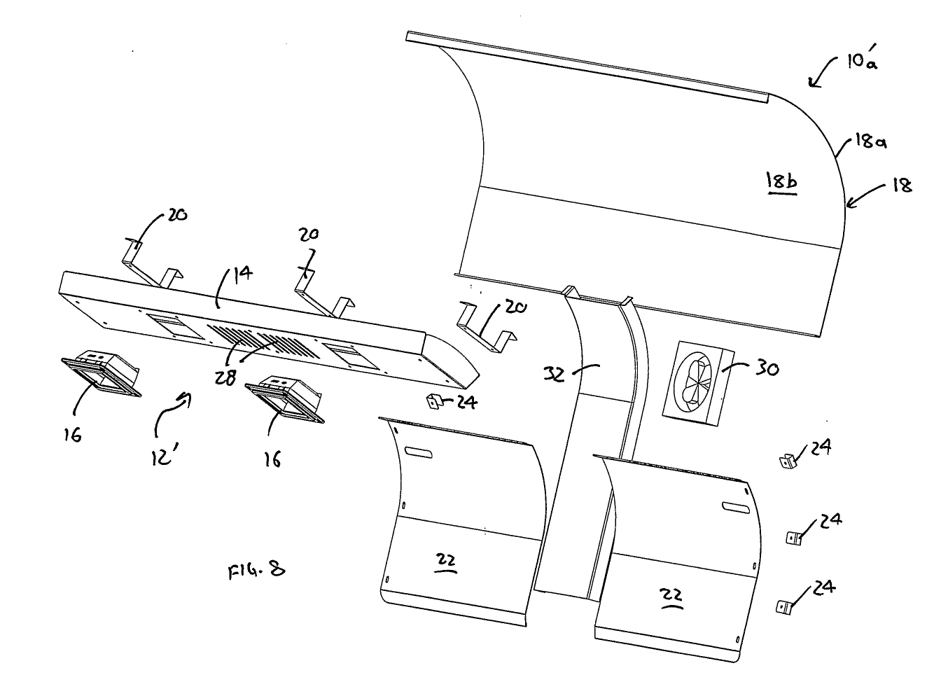

A second embodiment of hood rear part 10a′ and lighting arrangement 12′ are shown in FIGS. 6 to 8. The arrangements 10a′, 12′ are similar to those previously described and like reference numerals are used to indicate like features. However, in the second embodiments, the light housing 14 includes a number of slotted vent openings 28, which are in fluid communication with the volume enclosed between the light housing 14 and the hood panel 18. That volume is also in fluid communication with an exhaust fan 30 via a duct 32. Accordingly, when the fan is energised, gases (for example, smoke from cooking) are advantageously evacuated from adjacent the barbeque cooking surface 26.

Although the invention has been described with reference to preferred embodiments, it will be appreciated by those persons skilled in the art that the invention can be embodied in many other forms.

1. A lighting arrangement for a barbeque hood, the lighting arrangement including;
a light housing adapted for mounting adjacent an interior surface of the hood; and
at least one light mounted to the light housing.

2. The lighting arrangement as claimed in claim 1, further including at least one bracket between the hood and the light housing.

3. The lighting arrangement as claimed in claim 2, wherein the bracket(s) is/are attached to the hood by welding and to the light housing by screws.

4. A barbeque hood, the hood including:
a hood panel with an exterior and an interior surface
a light housing mounted adjacent the interior surface of the hood; and
at least one light mounted to the light housing.

5. The barbeque hood as claimed in claim 4, wherein the hood includes at least one bracket between the hood panel and the light housing.

6. The barbeque hood as claimed in claim 5, wherein the bracket(s) is/are attached to the hood panel by welding and to the light housing by screws.

7. The barbeque hood as claimed in claim 4, wherein the light housing and the hood panel together define an enclosed volume and the hood also includes a fan adapted to remove air from the volume.

8. The barbeque hood as claimed in claim 7, wherein the light housing includes at least one vent opening therein.

9. The barbeque hood as claimed in claim 7 wherein the fan is in fluid communication with the volume via a duct.

10. The barbeque hood as claimed in claim 7, wherein the fan is mounted to the hood panel.

11. The barbeque hood as claimed in claim 4, wherein the hood also includes at least one hood lining mounted to, and spaced apart, from the hood panel.

12. The barbeque hood as claimed in claim 4, wherein the hood includes a rear part and a front part.

13. The barbeque hood as claimed in claim 12, wherein the rear part is fixed to the barbeque.

14. The barbeque hood as claimed in claim 12, wherein the light housing is mounted to the rear part.

15. The barbeque hood as claimed in claim 12, wherein the front part is pivotally mounted to the rear part.
